(19) United States
(12) Patent Application Publication
(10) Pub. No.: US 2011/0221822 A1
(43) Pub. Date: Sep. 15, 2011

(54) LIQUID EJECTION HEAD AND LIQUID EJECTION APPARATUS

(75) Inventors: Hiroyuki HAGIWARA, Matsumoto-shi (JP); Noriaki OKAZAWA, Shiojiri-shi (JP); Sumio ARAI, Shiojiri-shi (JP); Yohei NODA, Matsumoto-shi (JP)

(73) Assignee: SEIKO EPSON CORPORATION, Tokyo (JP)

(21) Appl. No.: 13/010,198

(22) Filed: Jan. 20, 2011

(30) Foreign Application Priority Data
Mar. 12, 2010 (JP) 2010-056800

(51) Int. Cl. B41J 2/135

(52) U.S. Cl. 347/44

(57) ABSTRACT

A liquid ejection head and a liquid ejection apparatus improved in printing quality by reducing the occurrence of chipping at an opening edge of a positioning hole by a positioning pin are provided. The liquid ejection head includes a head body having a nozzle opening that discharges ink, a base plate provided with the positioning pin, and a positioning plate formed of a silicon substrate and provided with the positioning hole, and the head body is arranged at a predetermined position on the base plate by inserting the positioning pin through the positioning hole, and the opening edge of the positioning hole on the side from which the positioning pin is inserted is chamfered.

The entire disclosure of Japanese Patent Application No: 2010-056800, filed Mar. 12, 2010 are expressly incorporated by reference herein.

### BACKGROUND

1. Technical Field

The present invention relates to a liquid ejection head and a liquid ejection apparatus configured to eject liquid and, more specifically, to an ink jet recording head and an ink jet recording apparatus configured to discharge ink as the liquid.

2. Related art

A liquid ejection apparatus typified by an ink jet recording apparatus such as an ink jet printer or plotter includes a liquid ejection head (hereinafter, referred to also as “head”) having a plurality of liquid ejection head bodies which are capable of ejecting liquid such as ink stored in a cartridge or a tank in the form of liquid droplets.

The plurality of liquid ejection head bodies are placed on a base plate, which is a common holding member, and are arranged in such a manner that nozzle rows, which are nozzle openings arranged in a line, of the respective liquid ejection head bodies continue in the direction of the arrangement of the nozzle openings.

The respective liquid ejection head bodies are mounted on the base plate with a high relative positioning accuracy among the nozzle rows. Such positioning is achieved, for example, by providing positioning pins on the base plate as references for arranging the liquid ejection head bodies at predetermined positions, providing the each liquid ejection head body with a positioning plate having a positioning hole to allow the insertion of the positioning pin as a reference, and inserting the positioning pins through the positioning holes (for example, see JP-A-2010-030297).

There is another example of the liquid ejection head including a nozzle plate having the nozzle opening formed therethrough, a flow-channel-containing substrate provided with flow channels for supplying ink to the nozzle openings, and a protection substrate configured to protect the flow-channel-containing substrate (for example, see JP-A-2007-30379). In the case of the liquid ejection head, positioning among the respective members is achieved by forming the positioning holes through the respective members and inserting the positioning pin through the respective positioning holes.

However, in the case of the liquid ejection heads disclosed in JP-A-2010-030297 or JP-A-2007-30379, the positioning plate and the flow-channel-containing substrate are formed of silicon substrates, and opening edges of the positioning holes form a substantially right angle. Therefore, a distal end of the positioning pin inserted into the positioning hole is liable to collide with the opening edges, and this collision may cause chipping at the opening edges. The chipping may lower the strength of the positioning plate. The chipping may also cause a deformation of the positioning holes and a rattle between the positioning pin and the positioning hole. Consequently, the positioning accuracy may be lowered. In addition, intrusion of minute foreign substances generated by the chipping between the members or into ink flow channels may occur, so that the printing quality may be deteriorated.

Such problems exist not only in the ink jet recording head, but also in the liquid ejecting head which ejects liquid other than ink. Such problems exist not only when the positioning plate and the flow-channel-containing substrate are formed of silicon substrates, but also when these plates are formed of brittle material such as glass.

### SUMMARY

An advantage of some aspects of the invention is that a liquid ejection head and a liquid ejection apparatus improved in printing quality by reducing the occurrence of chipping at an opening edge of a positioning hole caused by a positioning pin are provided.

A first aspect of the invention in which the above-described problems are solved is a liquid ejection head including a first member, and a second member formed of a brittle material, the first member and the second member being positioned with respect to each other by a positioning pin arranged at a predetermined position of the first member being inserted through a positioning hole formed on the second member, wherein only an opening edge of the positioning hole on the side from which the positioning pin is inserted is chamfered.

In this configuration, the opening edge of the positioning hole of the second member is prevented from being chipped. Accordingly, lowering of the strength of a positioning plate is prevented. In addition, lowering of the positional accuracy due to occurrence of the rattle between the positioning pin and the positioning hole is prevented, and hence high quality discharge of liquid droplets is achieved. In addition, since formation of minute foreign substrates due to the chipping of the second member is prevented, lowering of liquid droplet discharging characteristics due to intrusion of the foreign substances between the members or into the liquid flow channel is prevented. Only the opening edge of the second member on the side from which the positioning pin is inserted is chamfered, and the opening edge on the other side is not chamfered. Accordingly, it is easy to know whether or not the positioning hole is formed into shape and size adequate for allowing the positioning pins to be inscribed in.

Preferably, a head body having a nozzle opening configured to discharge liquid is provided, the first member is a base plate having the positioning pin provided thereon, and the second member is a positioning plate formed with the positioning hole and provided on the head body so as to achieve a predetermined relative position between the nozzle opening and the positioning hole. Accordingly, there is provided a liquid ejection head having such configuration that the positioning hole allows insertion of the positioning pin repeatedly therethrough, and the head body is demountably mounted on the base plate. Since the chipping of the positioning plate due to the positioning pin can hardly occur, high-quality discharge of liquid droplets is achieved.

Preferably, a surface of the positioning plate opposite from a side from which the positioning pin is inserted is mirror finished. In this configuration, since the contrast between the positioning hole of the positioning plate and an area other than the positioning hole is prominent, it is further easier to know the size and shape of the positioning hole adequately.

Preferably, the positioning hole is formed by forming a through hole by etching the second member, and chamfering the periphery of one of the opening edges of the through hole by half etching. Accordingly, the opening edge can be adequately chamfered.

Preferably, the first member is a nozzle plate provided with the nozzle opening that discharges the liquid, the second member is a flow-channel-containing substrate to which the nozzle plate is joined, and the second member includes a pressure generating unit having a pressure generating chamber communicating with the nozzle opening and causes a pressure change in the pressure generating chamber, and the positioning hole is formed on the flow-channel-containing substrate. In this configuration, in the liquid ejection head having the flow-channel-containing substrate to which the nozzle plate is joined, occurrence of the chipping on the opening edge of the positioning hole on the flow-channel-containing substrate due to the positioning pin is prevented.

Another aspect of the invention is a liquid ejection apparatus wherein the liquid ejection head as described above is provided. In this configuration, there is provided a liquid ejection apparatus in which lowering of the liquid discharging characteristics is prevented.

### BRIEF DESCRIPTION OF THE DRAWINGS

The invention will be described with reference to the accompanying drawings, wherein like numbers reference like elements.

FIG. 1 is a schematic perspective view of a head according to a first embodiment.

FIG. 2 is a schematic perspective view of a head body according to the first embodiment.

FIG. 3 is a plan view of the head according to the first embodiment.

FIG. 4 is a cross-sectional view taken along the line IV-IV in FIG. 3.

FIGS. 5A to 5C are a plan view, a back view, and a cross-sectional view of a positioning plate.

FIG. 6 is a schematic configuration drawing of a liquid ejection apparatus according to the first embodiment.

FIG. 7 is an exploded perspective view of a head according to a second embodiment.

FIG. 8 is a cross-sectional view passing through a pressure generating chamber of the head according to the second embodiment.

FIG. 9 is a cross-sectional view passing through a positioning hole of the head according to the second embodiment.

### DESCRIPTION OF EXEMPLARY EMBODIMENTS

The invention will be described in detail on the basis of embodiments.

### First Embodiment

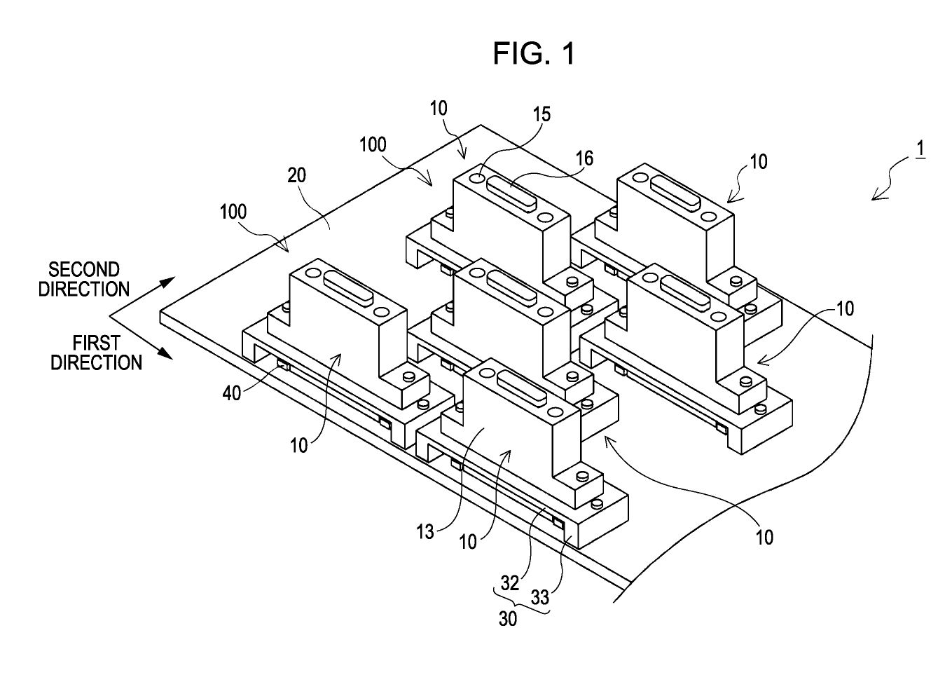

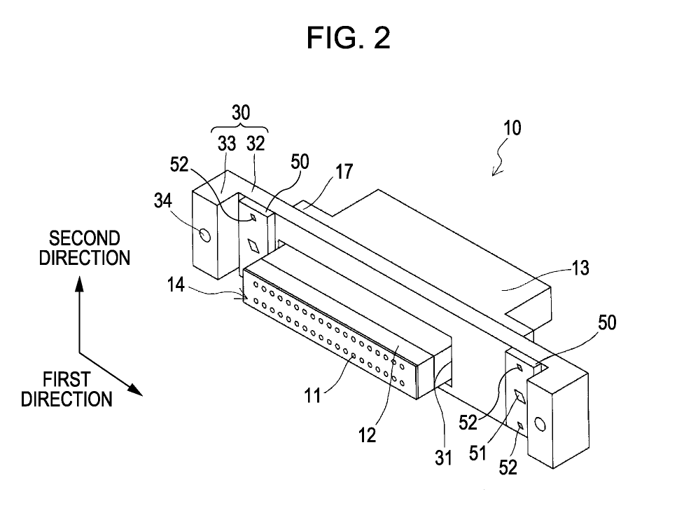

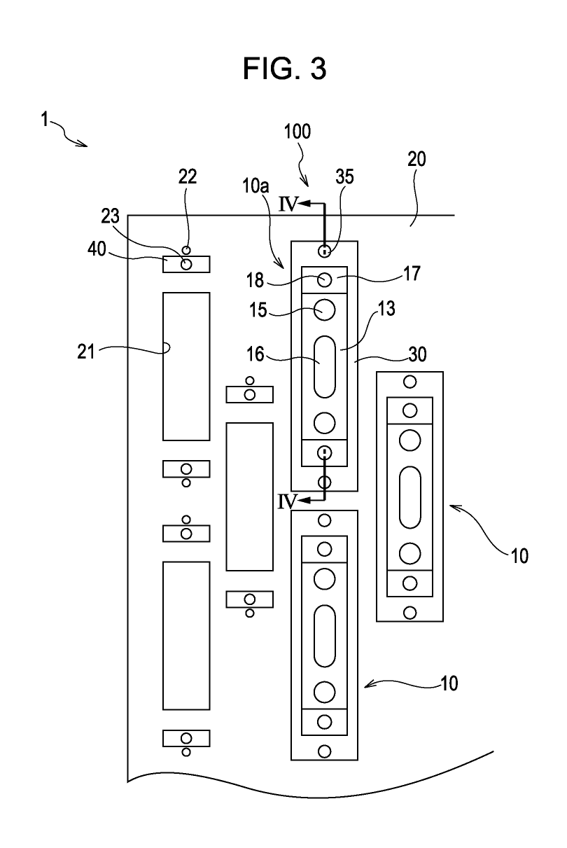

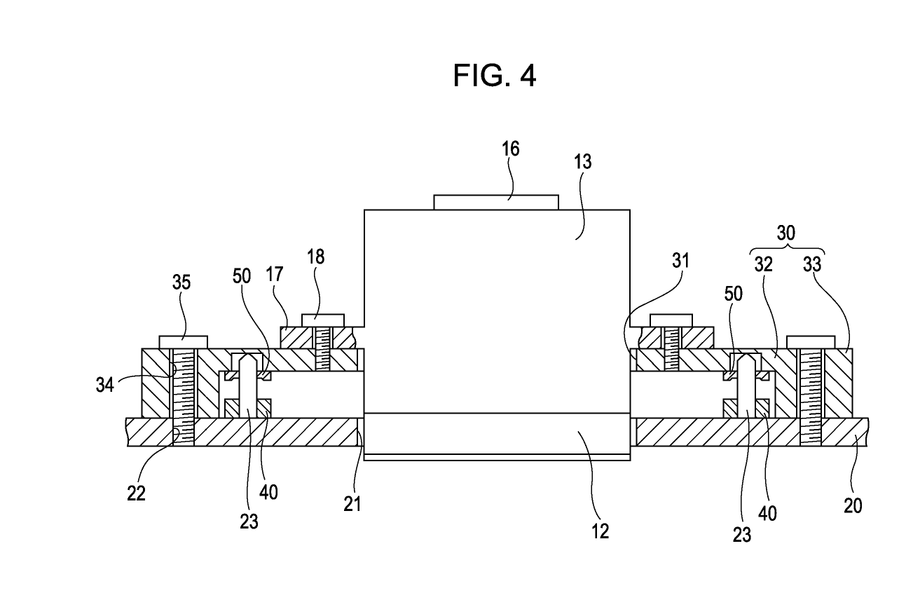

FIG. 1 is a schematic perspective view of an ink jet recording head as an example of a liquid ejection head according to a first embodiment of the invention. FIG. 2 is a schematic perspective view of a head body provided in the ink jet recording head. FIG. 3 is a plan view of the ink jet recording head according to the first embodiment of the invention. FIG. 4 is a cross-sectional view taken along the line IV-IV in FIG. 3.

As indicated in the drawings, an ink jet recording head 1 in this embodiment (hereinafter, referred to also as “head”) includes a plurality of ink jet recording head bodies 10 (hereinafter, referred to also as “head body”), a base plate 20 (first member) on which the head bodies 10 are placed, and positioning plates 50 (second member) configured to arrange the head bodies 10 at predetermined positions on the base plate 20.

The base plate 20 is formed with through holes 21, one for each head body 10, so as to penetrate therethrough in the direction of the thickness thereof. Each head body 10 is fixed to the base plate 20 via a sub-plate 30 in a state in which the head bodies 10 are inserted into the through holes 21.

The through hole 21 is formed to have an opening slightly larger than the outer periphery of the head body 10 and smaller than the sub-plate 30. Therefore, when the head body 10 is inserted into the through hole 21, the sub-plate 30 of the head body 10 is held on the base plate 20. Since a gap is provided between the head body 10 and the through hole 21, the head body 10 is slightly movable with respect to the base plate 20 in a first direction and a second direction.

The base plate 20 is provided with positioning pins 23 supported by supporting members 40 at predetermined positions. The expression “the positioning pins 23 are provided at predetermined positions on the base plate 20” means that the positioning pins 23 are formed on the base plate 20 so that the relative positions of the plurality of head bodies 10 are fixed as determined when the positioning pins 23 are inserted into positioning holes 51 of the positioning plates 50.

In this embodiment, the predetermined positions of the head bodies 10 are as follows. As shown in FIG. 1 and FIG. 3, the plurality of head bodies 10 are arranged in the first direction, that is, in the direction of the arrangement of nozzle openings 11 of nozzle rows 14 (see FIG. 2) of the head bodies 10, to constitute a head group 100 (three head bodies 10 which constitute one head group 100 are shown in the drawing), and two head groups 100 are arranged in the second direction.

In detail, the plurality of head bodies 10 which constitute one head group 100 are arranged in a zigzag pattern along the first direction so that the nozzle rows 14 are continued in the first direction. Then, two head groups 100 are juxtaposed in the second direction.

The expression “the nozzle rows 14 of each head group 100 continue in the first direction” means that nozzle openings 11 at an end of the nozzle row 14 of one of the head bodies 10 adjacent to each other in the second direction and nozzle openings 11 at an end of the nozzle row 14 of the other head body 10 are arranged at the same position in the first direction.

In this manner, since the nozzle rows 14 of the plurality of head bodies 10 are arranged so as to continue in the first direction in the respective head groups 100, printing in a wider range is achieved at a higher speed in comparison with the case where the printing is performed with the nozzle rows 14 of one head body 10.

As shown in FIG. 2 and FIG. 4, the head body 10 includes a head member 12 having the nozzle openings 11 at one end surface thereof, and a flow channel member 13 fixed to a surface of the head member 12 opposite from the nozzle openings 11. In this embodiment, the head body 10 is provided with the sub-plate 30 to be fixed to the base plate 20, and the sub-plate 30 is provided with the positioning plates 50 as an example of the second member.

The head member 12 includes the nozzle rows 14 having the nozzle openings 11 arranged in a line. The number of the nozzle rows 14 is not specifically limited and, for example, may be one, or two or more. In this embodiment, two nozzle rows 14 are provided on one head member 12. In this embodiment, the direction in which the nozzle openings 11 of the nozzle row 14 are arranged in a line is defined as the first direction, and the direction intersecting the first direction is defined as the second direction. Therefore, the two nozzle rows 14 are juxtaposed in the second direction.

In the interior of the head member 12, although it not shown in the drawing, there are a pressure generating chamber, which constitutes part of a flow channel communicated with the nozzle openings 11, and a pressure generating unit configured to generate a pressure change in the pressure generating chamber to cause ink to be discharged from the nozzle openings.

The configuration of the pressure generating unit is not specifically limited and, for example, a configuration employing a piezoelectric element having two electrodes and a piezoelectric material having a function of an electromechanical transducer interposed therebetween, a configuration having a heat generating element arranged in the pressure generating chamber and causing liquid droplets to be discharged from the nozzle openings 11 by bubbles generated by the heat of the heat generating element, or a configuration to generate static electricity between a diaphragm and an electrode to deform the diaphragm by the static electricity and causing liquid droplets to be discharged from the nozzle openings 11 may be employed. The piezoelectric element may be a flexural oscillation piezoelectric element configured to be flexurally deformed by being formed by laminating a lower electrode, the piezoelectric material, and an upper electrode in sequence from the side of the pressure generating chamber, or a vertical oscillation piezoelectric element configured to expand and contract in the axial direction by being formed by laminating piezoelectric materials and electrode materials alternately to cause expansion and contraction in the axial direction.

The flow channel member 13 is configured to be fixed on a surface of the head member 12 on the opposite side from the nozzle openings 11, and supply ink from the outside to the head member 12 or discharge ink from the head member 12 to the outside. Provided on the surface of the flow channel member 13 opposite from the surface fixed to the head member 12 are liquid flow channel ports 15 which are openings of the internal flow channels and allow external flow channels to be connected thereto, and a connector 16 which receives supply of electric signals such as printing signals from the outside.

The head body 10 is provided with flange portions 17 on both sides in the first direction so as to project outward, and the flange portion 17 is fixed to the sub-plate 30 via fixing screws 18.

The sub-plate 30 is a member for mounting the head body 10 to the base plate 20 and, more specifically, includes a base portion 32 formed with a head through hole 31 and leg portions 33 provided on one side of the base portion 32.

The flange portions 17 are fixed to the base portion 32 of the sub-plate 30 in a state in which the head body 10 is inserted into the head through hole 31. The leg portions 33 of the sub-plate 30 are formed with fixing screw insertion holes 34 penetrated therethrough in the thickness direction. The sub-plate 30 is fixed to the base plate 20 by screwing fixing screws 35 in a state of being inserted through the fixing screw insertion holes 34 into fixing screw holes 22 provided on the base plate 20. The fixing screw insertion holes 34 have a diameter slightly wider than that of the fixing screw 35, and the sub-plate 30 is slightly movable in the first direction and the second direction. This configuration is intended to allow fine adjustment of the position of the sub-plate 30 with respect to the base plate 20 when inserting the positioning pins 23 into the positioning holes 51 provided on the positioning plates 50.

Two the positioning plates 50 are attached to the sub-plate 30 on the surface of the base portion 32 on the side of the nozzle opening 11 so as to be disposed on either side of the through hole 21. The positioning plates 50 are each formed of silicon substrate and are each formed with positioning adjustment holes 52 and one of the positioning holes 51.

The positioning holes 51 are through holes which allow insertion of the positioning pins 23 provided on the base plate 20, and the positioning adjustment holes 52 are holes used for positioning when attaching the positioning plates 50 to the sub-plate 30. The positioning adjustment holes 52 and the positioning holes 51 are formed in their predetermined relative positions through a photolithography method.

The positioning plates 50 are attached to the sub-plate 30 in a state in which the positioning adjustment holes 52 and the nozzle openings 11 are located at predetermined positions. Here, the expression “the positioning adjustment holes 52 and the nozzle opening 11 are located at predetermined positions” means that the positioning adjustment holes 52 are located at positions apart from the nozzle openings 11 by a predetermined distance in the first direction and the second direction in plan view when the head body 10 is viewed from the side of the nozzle openings 11.

In this manner, since the positioning adjustment holes 52 and the nozzle openings 11 are formed in the predetermined arrangement and the positioning adjustment holes 52 and the positioning holes 51 are formed in the predetermined arrangement, the relative positions of the positioning holes 51 and the nozzle openings 11 are controlled with a high degree of accuracy. In other words, by inserting the positioning pins 23 through the positioning holes 51 of the positioning plates 50 of the head bodies 10, the nozzle openings 11 of the head bodies 10 are arranged while maintaining a relative distance between the head bodies.

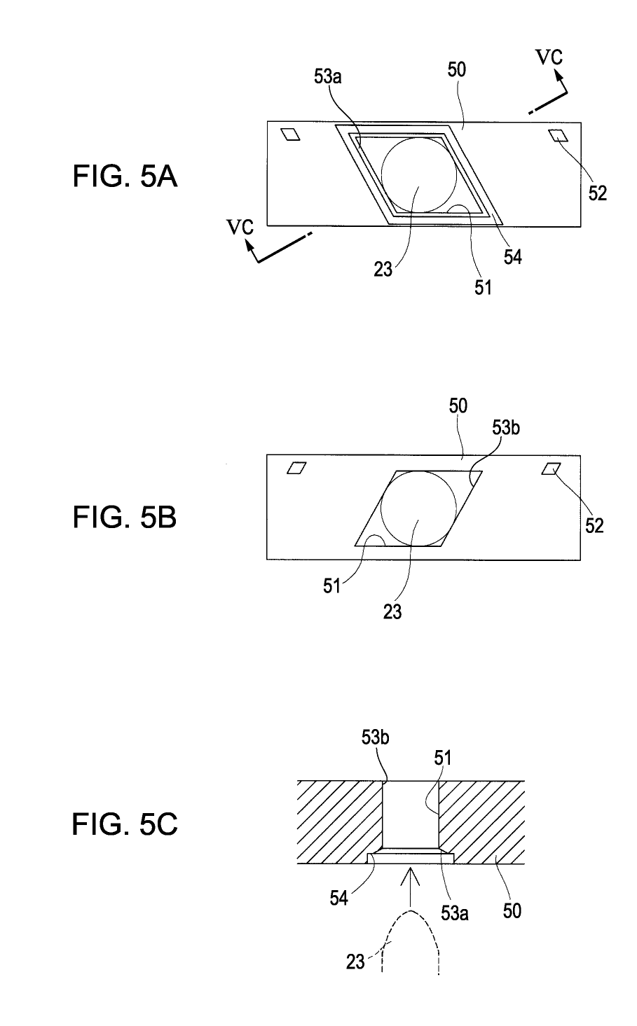

Here, the positioning plate 50 will be described in detail. FIG. 5A is a plan view of the positioning plate on the side from which the positioning pin is inserted. FIG. 5B is a back view of the positioning plate. FIG. 5C is a cross-sectional view taken along the line VC-VC in FIG. 5A. The surface shown in FIG. 5A is referred to also as a front surface, and the surface shown in FIG. 5B is referred to also as a back surface.

As shown in FIGS. 5A and 5C, the positioning plate 50 formed of the silicon substrate is formed with the positioning hole 51 for allowing the insertion of the positioning pin 23. The opening of the positioning hole 51 has the geometry shape of a diamond, and the lateral cross-section of the positioning pins 23 has the geometry shape of a circle inscribed in the shape of the opening of the positioning hole 51. The positioning plate 50 whose positioning hole 51 allows insertion of the positioning pins 23 therethrough is restricted from moving in the direction of the plane (the first direction and the second direction) by the positioning pins 23. Therefore, the position of the head body 10 with respect to the base plate 20 is fixed via the positioning plate 50.

An opening edge 53a on the front side, which is one of opening edges 53a, 53b opening on the front surface and the back surface of the positioning hole 51 and allows insertion of the positioning pins 23 therethrough, is chamfered.

In this manner, with the formation of the chamfer at the opening edge 53a which allows the insertion of the positioning pins 23, the distal end portion of the positioning pins 23 is guided into the positioning hole 51 by the chamfered opening edge 53a. Accordingly, the positioning pins 23 can be guided easily into the positioning hole 51, and an impact caused by the positioning pins 23 colliding against the opening edge 53a is alleviated, so that occurrence of chipping at the opening edge 53a is avoided.

The opening edge 53a can be formed in the following manner. First of all, a photoresist pattern is formed on the positioning plate 50 so that the positioning hole 51 and the positioning adjustment holes 52 are formed at predetermined positions, and etching is applied to form the through holes. Subsequently, half etching is applied to the surface of the positioning plate 50 in peripheral areas of the positioning hole 51 to form a stepped portion 54. When forming the stepped portion 54, the opening of the positioning hole 51 is chamfered, so that the chamfered opening edge 53a is formed.

In this embodiment, the positioning plate 50 is formed of a silicon substrate. However, it is not specifically limited as long as it is a brittle material which easily chips due to the collision of the positioning pins 23. Examples of the brittle material which can be employed here include glass. The method of chamfering the opening edge 53a is not limited to the photolithography method, and it may be chamfered by machining.

As shown in FIGS. 5B and 5C, the opening edge 53b of the positioning hole 51 is not chamfered. In other words, the opening appearing on the back side of the positioning plate 50 has exactly the same shape as that in which the positioning pin 23 is inscribed.

With the provision of the opening edge 53b which is not chamfered, it is easy to know whether or not the positioning hole 51 is formed into a shape and size adequate for allowing the positioning pin 23 to be inscribed therein because it is difficult to know the size and shape of a portion of the positioning hole in which the positioning pin 23 is inscribed on the front surface since the stepped portion 54 and the opening edge 53a are visible and only the positioning hole 51 (the opening edge 53b) is visible on the back surface.

Furthermore, the back surface of the positioning plate 50 is mirror finished. Since the back surface is mirror finished, the contrast between the positioning hole 51 of the positioning plate 50 and an area other than the positioning hole 51 is prominent, so that it is further easier to know the size and shape of the positioning hole 51 adequately.

As described above, the opening edge 53a of the positioning plate 50 is prevented from being chipped. Accordingly, lowering of the strength of the positioning plate 50 is prevented. In addition, lowering of the positional accuracy due to occurrence of the rattle between the positioning pin 23 and the positioning hole 51 because of the chipping is prevented, and hence high quality printing is achieved. Furthermore, since formation of minute foreign substances due to the chipping of the positioning plate 50 is prevented, lowering of the printing quality due to intrusion of the foreign substances between the members which constitute the head body 10 or into the ink flow channels is also prevented.

The ink jet recording head 1 in this embodiment has a configuration in which the head bodies 10 and the sub-plates 30 are demountably mounted on the base plate 20, and hence the positioning holes 51 allows insertion of the positioning pins 23 repeatedly therethrough. Even in this configuration, since the positioning plate 50 can hardly be chipped as described above, the high quality printing is achieved.

The ink jet recording head 1 in this embodiment can be applied to a line ink jet recording apparatus, for example, which performs printing on a recording medium by transporting the recording medium such as recording paper in the direction orthogonal to the direction of the nozzle row.

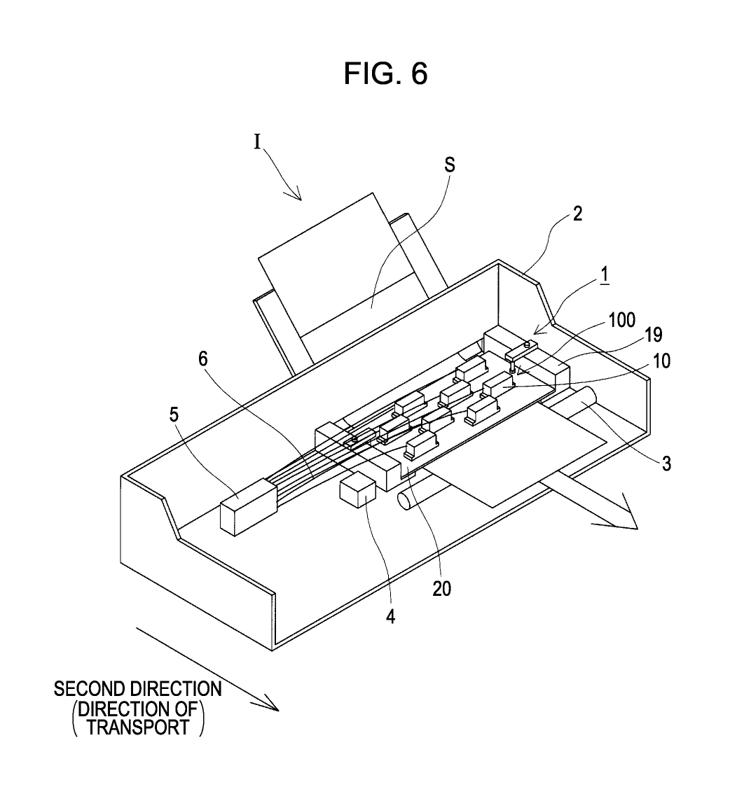

For example, the ink jet recording apparatus I shown in FIG. 6 includes the head 1 described above, an apparatus body 2, a paper feed roller 3 as an example of transporting device, and a control unit 4.

The head 1 includes the head groups 100 having the plurality of head bodies 10 (the respective head groups 100 include four head bodies 10 in FIG. 6), and the base plate 20 having the head groups 100 held thereon. The head 1 is fixed to the apparatus body 2 via a frame member 19.

The apparatus body 2 is provided with the paper feed roller 3. The paper feed roller 3 transports a recording sheet S (ejected medium) such as paper fed to the apparatus body 2 in the second direction, and passes the recording sheet S by the head 1 on the side of the ink discharge surface. Here, the second direction means the direction of relative movement between the recording sheet S and the head 1. In this embodiment, since the head 1 is fixed to the apparatus body 2, the direction in which the recording sheet S is transported by the paper feed roller 3 corresponds to the second direction. Hereinafter, the second direction is referred to as “direction of transport”.

The apparatus body 2 is provided with an ink storage unit 5 in which ink is stored, and the ink is supplied to the respective head bodies 10 via supply tubes 6.

The control unit 4 is configured to transmit a signal to the paper feed roller 3 on the basis of printing data which indicates an image to be printed on the recording sheet S to cause the paper feed roller 3 to transport the recording sheet S, and transmit drive signals to the respective head bodies 10 via wiring, not shown, to cause the head bodies 10 to discharge ink.

In the ink jet recording apparatus I as described above, the recording sheet S is transported by the paper feed roller 3 in the direction of transport and ink is discharged by the head bodies 10 of the head 1, so that an image or the like is printed on the recording sheet S.

The head 1 in this embodiment can be applied not only to the line ink jet recording apparatus shown in FIG. 6, but also to ink jet recording apparatus of other types. For example, it can be applied to the ink jet recording apparatus of a type which performs printing while moving a carriage having a head mounted thereon in the direction orthogonal to the direction of transport of the recording medium.

### Second Embodiment

In the first embodiment, the first member is the base plate 20 and the second member is the positioning plate 50. However, the invention is not limited thereto. For example, the invention may be applied to a liquid ejection head including a plurality of members.

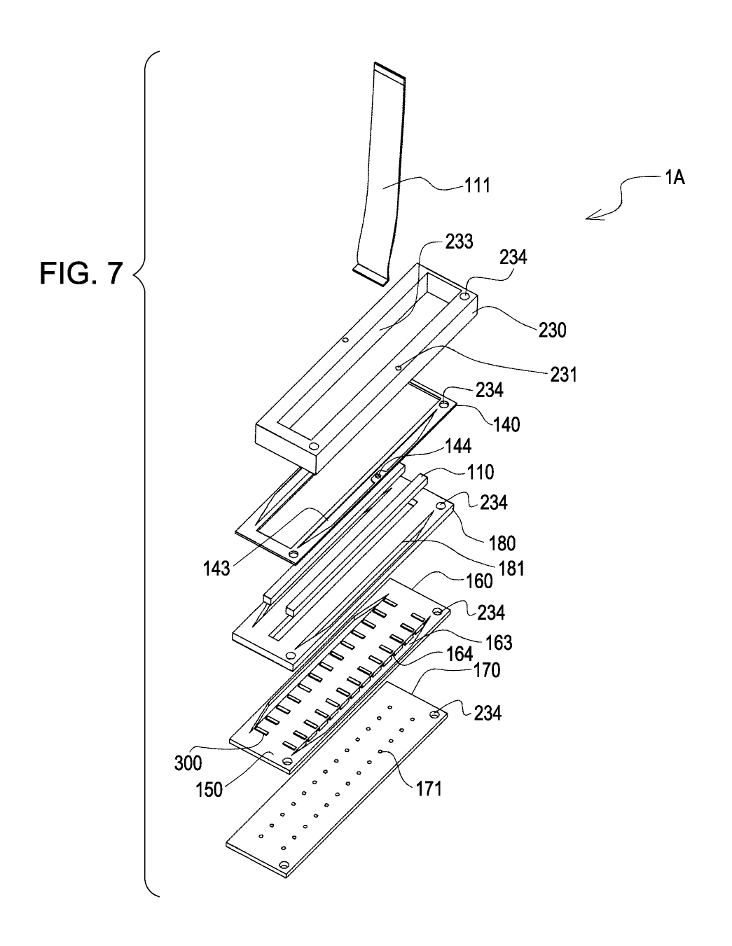

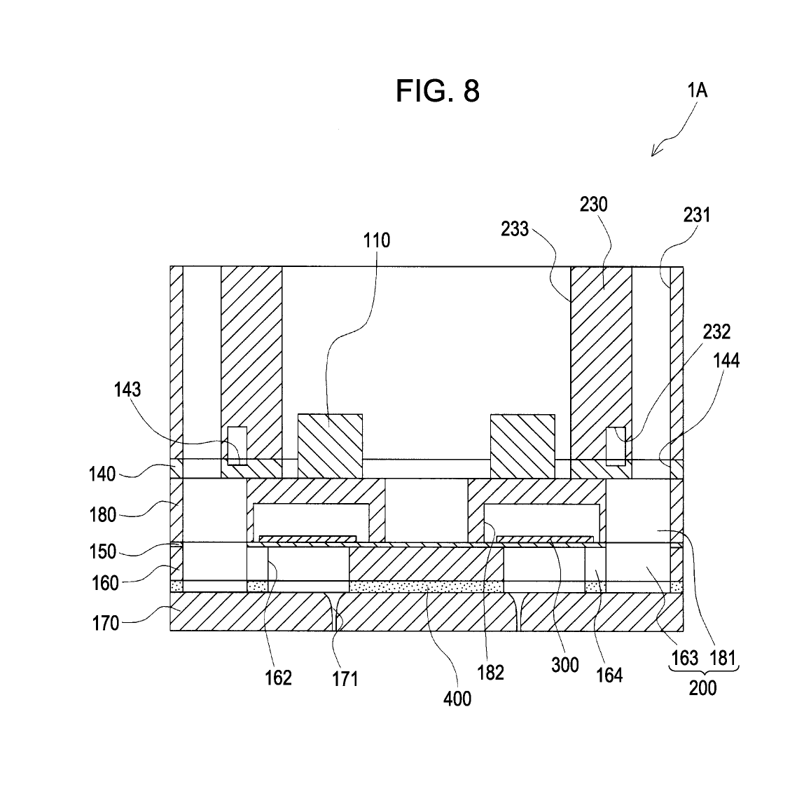

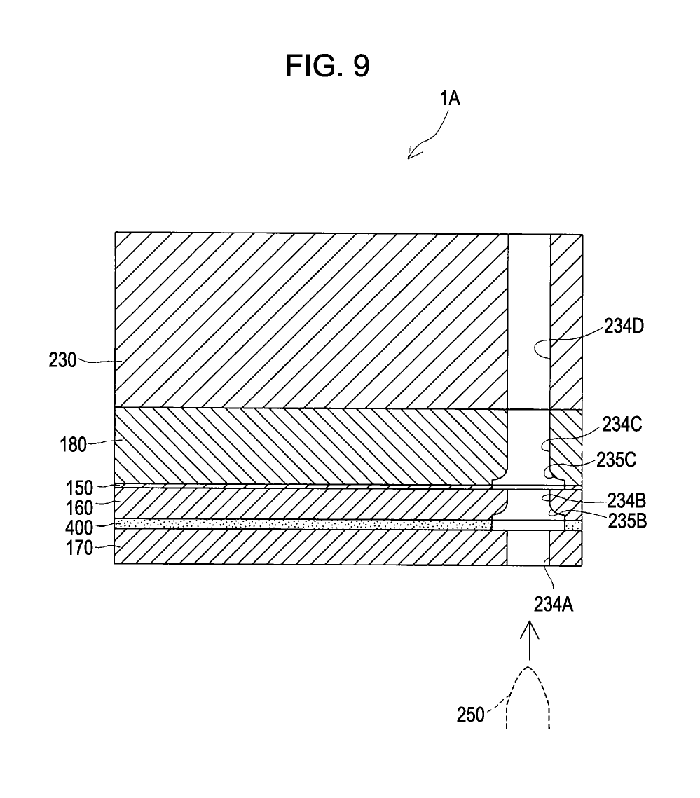

FIG. 7 is an exploded perspective view of a head. FIG. 8 is a cross-sectional view passing through a pressure generating chamber of the head. FIG. 9 is a cross-sectional view passing through a positioning hole of the head.

A head 1A according to a second embodiment will be described on the basis of FIG. 7 to FIG. 9. The head 1A in this embodiment corresponds to the head member 12 in the first embodiment.

As shown in the drawings, a flow-channel-containing substrate 160 (second member) which constitutes the head 1A is formed of a silicon monocrystal substrate in this embodiment, and is formed with a resilient film 150 formed of silicon dioxide on one of the surfaces. The flow-channel-containing substrate 160 is formed with two rows of pressure generating chambers 162 partitioned by a plurality of partitioning walls arranged side by side in the widthwise direction by applying anisotropic etching from the other surface. Formed on the outer sides of the respective rows of the pressure generating chambers 162 in the longitudinal direction are communicating portions 163 which constitute reservoirs 200 communicating with reservoir portions 181 provided on a reservoir forming substrate 180, described later, and serve as common ink chambers of the respective pressure generating chambers 162. The each communicating portion 163 communicates with one end of the each pressure generating chamber 162 in the longitudinal direction via a supply channel 164. In other words, in this embodiment, the pressure generating chambers 162, the communicating portions 163, and the supply channels 164 are provided as liquid flow channel formed on the flow-channel-containing substrate 160.

A nozzle plate 170 (first member) formed with nozzle openings 171 is secured to the flow-channel-containing substrate 160 on the side of the opening via an adhesive agent 400. The nozzle openings 171 of the nozzle plate 170 are each formed at a position communicating with the each pressure generating chamber 162 on the opposite side of the supply channel 164. In this embodiment, the nozzle plate 170 is formed of metallic plate such as stainless steel (SUS).

In contrast, piezoelectric elements 300 are formed on the resilient film 150 on the surface of the flow-channel-containing substrate 160 opposite from the opening surface. The reservoir forming substrate 180 having reservoir portions 181 which constitute at least part of the reservoir 200 is joined to the flow-channel-containing substrate 160 formed with the piezoelectric elements 300. The reservoir portions 181 in this embodiment are formed across the widthwise direction of the pressure generating chamber 162 so as to penetrate through the reservoir forming substrate 180 in the thickness direction, and is communicated with the communicating portions 163 of the flow-channel-containing substrate 160 as described above, thereby constituting the reservoir 200 which is a common ink chamber for the respective pressure generating chambers 162.

Provided in an area opposing the each piezoelectric element 300 on the reservoir forming substrate 180 is a piezoelectric element holding portion 182 having an enough space not to hinder the movement of the piezoelectric element 300.

In addition, drive circuits 110 formed of semiconductor integrated circuit (IC) configured to drive the respective piezoelectric elements 300 are provided on the reservoir forming substrate 180. Respective terminals of the drive circuit 110 are connected to leading wires led from individual electrodes of the respective piezoelectric elements 300 via the boning wires or the like, not shown. Then, the respective terminals of the drive circuit 110 are connected to the outside via an external wiring 111 such as a flexible printed board (FPC) and are configured to receive a variety of signals such as printing signals or the like via the external wiring 111 from the outside.

A compliance substrate 140 is joined to the reservoir forming substrate 180 configured as described above. Ink introduction ports 144 for supplying ink to the reservoirs 200 are formed in areas of the compliance substrate 140 opposing the reservoirs 200 by being penetrated therethrough. Areas of the compliance substrate 140 opposing the reservoirs 200 except for the ink introduction ports 144 constitute flexible portions 143 reduced in thickness, and the reservoirs 200 are sealed by the flexible portions 143. With the presence of the flexible portions 143, compliance is provided in the interior of the reservoirs 200.

A head case 230 is fixed onto the compliance substrate 140.

The head case 230 is provided with ink supply communication channels 231 which communicate with the ink introduction ports 144 and communicate also with an external ink supply member (not shown) to supply ink from the ink supply member to the ink introduction ports 144. The head case 230 is formed with groove portions 232 at areas opposing the flexible portions 143 of the compliance substrate 140, so that the flexible portions 143 are brought into flexural deformation as needed. The head case 230 is provided with a drive circuit holding portion 233 so as to penetrate through an area opposing the drive circuits 110 provided on the reservoir forming substrate 180 in the thickness direction. The external wiring 111 is inserted through the drive circuit holding portion 233 and is connected to the drive circuits 110.

The respective members which constitute the head 1A are provided at two corners thereof with positioning holes 234A to 234D respectively. The positioning holes 234A to 234D allow insertion of positioning pins 250 for the positioning of the respective members at the time of assembly. The head 1A can be assembled integrally by joining the members with respect to each other with the positioning pins 250 inserted in the positioning holes 234A to 234D for relative positioning of the respective members.

The head 1A in this embodiment as described above is configured in such a manner that after the interior thereof from the reservoirs 200 to the nozzle openings 171 via the ink supply communication channels 231 and the ink introduction ports 144 is filled with ink from the ink supply member, voltages are applied to the respective piezoelectric elements 300 corresponding to the respective pressure generating chambers 162 according to the recording signals from the drive circuit 110 to cause the resilient film 150 and the piezoelectric elements 300 into flexure deformation, whereby the pressures in the respective pressure generating chambers 162 are increased and hence ink droplets are discharged from the nozzle openings 171.

The flow-channel-containing substrate 160 as an example of the second member is formed of a silicon substrate, and the opening edges 235B of the positioning holes 234B on the side where the positioning pins 250 are inserted are chamfered.

In this manner, with the formation of the chamfer at the opening edges 235B where the positioning pins 250 are inserted, the distal end portions of the positioning pins 250 inserted through the positioning holes 234A of the nozzle plate 170, which is an example of the first member, are guided into the positioning holes 234B by the chamfered opening edges 235B. Accordingly, the positioning pins 250 can be guided easily into the positioning holes 234B, and an impact caused by the positioning pins 250 colliding against the opening edges 235B is alleviated, so that occurrence of chipping at the opening edges 235B is avoided.

The expression in Claim “a positioning pin arranged at a predetermined position of a first member” means, in this embodiment, the positioning pin 250 in a state of being inserted through the positioning hole 234A of the nozzle plate 170 when positioning the respective members which constitute the head 1A. In this embodiment, after having positioned and fixed the respective members, the positioning pins 250 are removed from the positioning holes 234A to 234D. Therefore, the head 1A in this embodiment includes the positioning holes 234A to 234D having positioned and communicated with respect to each other by the insertion of the positioning pin 250.

In this embodiment, the reservoir forming substrate 180 is formed of a silicon substrate, and the opening edges 235C of the positioning holes 234C on the side where the positioning pins 250 are inserted are also chamfered. With the formation of the chamfer at the opening edges 235C, occurrence of chipping at the opening edges 235C is avoided in the same manner as the case of the flow-channel-containing substrate 160 described above.

Although not specifically shown in the drawing, a configuration in which the nozzle plate 170 is formed of a silicon substrate, and the opening edges of the positioning holes 234A on the side from which the positioning pins 250 are inserted may be chamfered is also applicable.

### Other Embodiments

Although the embodiments of the invention have been descried thus far, the basic configuration of the invention is not limited to the configuration described above.

The opening edge 53a according to the first embodiment and the opening edges 235B and 235C according to the second embodiment are chamfered. However, the type of the chamfer is not specifically limited, and may be, so-called, a C-chamfer or, alternatively, the opening edges may be chamfered into an R-shape.

In addition, the invention is aimed generally at a wide range of liquid ejection heads. For example, the invention can be applied to recording head such as a variety of ink jet recording heads used for an image recording apparatus such as printers, coloring material ejection head used for manufacturing color filters such as liquid crystal displays, electrode material ejection head used for forming electrodes for displays such as organic EL displays or FED (field emission displays), and also biological organic substance ejection heads used for manufacturing biological chips.

What is claimed is:

1. A liquid ejection head comprising:
a first member; and
a second member formed of a brittle material, the first member and the second member being positioned with respect to each other by a positioning pin arranged at a predetermined position on the first member being inserted through a positioning hole formed on the second member,
wherein only an opening edge of the positioning hole on the side from which the positioning pin is inserted is chamfered.

2. The liquid ejection head according to claim 1, comprising: a head body having a nozzle opening configured to discharge liquid,
wherein the first member is a base plate having the positioning pin provided thereon, and
the second member is a positioning plate formed with the positioning hole and provided on the head body so as to achieve a predetermined relative position between the nozzle opening and the positioning hole.

3. The liquid ejection head according to claim 1, wherein a surface of the positioning plate opposite from a side from which the positioning pin is inserted is mirror finished.

4. The liquid ejection head according to claim 1, wherein the positioning hole is formed by forming a through hole by etching the second member, and chamfering the periphery of one of the opening edges of the through hole by half etching.

5. The liquid ejection head according to claim 1, wherein the first member is a nozzle plate provided with the nozzle opening that discharges the liquid,
the second member is a flow-channel-containing substrate to which the nozzle plate is joined, and the second member includes a pressure generating unit having a pressure generating chamber communicating with the nozzle opening and causes a pressure change in the pressure generating chamber, and
the positioning hole is formed on the flow-channel-containing substrate.

6. A liquid ejection apparatus comprising a liquid ejection head, the liquid ejecting head comprising:
a first member; and
a second member formed of a brittle material, the first member and the second member being positioned with respect to each other by a positioning pin arranged at a predetermined position on the first member being inserted through a positioning hole formed on the second member,
wherein only an opening edge of the positioning hole on the side from which the positioning pin is inserted is chamfered.

7. The liquid ejection apparatus according to claim 6, the liquid ejecting head comprising:
a head body having a nozzle opening configured to discharge liquid,
wherein the first member is a base plate having the positioning pin provided thereon, and
the second member is a positioning plate formed with the positioning hole and provided on the head body so as to achieve a predetermined relative position between the nozzle opening and the positioning hole.

8. The liquid ejection apparatus according to claim 6, wherein a surface of the positioning plate opposite from a side from which the positioning pin is inserted is mirror finished.

9. The liquid ejection apparatus according to claim 6, wherein the positioning hole is formed by forming a through hole by etching the second member, and chamfering the periphery of one of the opening edges of the through hole by half etching.

10. The liquid ejection apparatus according to claim 1, wherein the first member is a nozzle plate provided with the nozzle opening that discharges the liquid,
the second member is a flow-channel-containing substrate to which the nozzle plate is joined, and the second member includes a pressure generating unit having a pressure generating chamber communicating with the nozzle opening and causes a pressure change in the pressure generating chamber, and
the positioning hole is formed on the flow-channel-containing substrate.
